(19) United States
(12) Patent Application Publication
(10) Pub. No.: US 2014/0074976 A1
(43) Pub. Date: Mar. 13, 2014

(54) APPARATUS, SYSTEM, AND METHOD FOR ANONYMOUS SHARING AND PUBLIC VETTING OF CONTENT

(71) Applicants: Amanda K. Greenberg, Pittsburgh, PA (US); Noah P. Bornstein, Pittsburgh, PA (US)

(72) Inventors: Amanda K. Greenberg, Pittsburgh, PA (US); Noah P. Bornstein, Pittsburgh, PA (US)

(21) Appl. No.: 14/021,892

(22) Filed: Sep. 9, 2013

Related U.S. Application Data
(60) Provisional application No. 61/698,298, filed on Sep. 7, 2012.
(60) Provisional application No. 61/699,043, filed on Sep. 10, 2012.

(51) Int. Cl. H04L 29/06

(52) U.S. Cl. CPC H04L 65/60
USPC 709/217

(57) ABSTRACT

In one embodiment, directed generally to an anonymous content publishing and distribution, an apparatus, system, and method for anonymous sharing and public vetting of content provides that posts will not display any of the identifiable publisher's information, but may include non-identifiable information, such as posting date. The apparatus, system, and method will enable the public to vote (both positively and negatively) on individual posts, with the resulting vote information being visible only to the publisher. Top-ranked content will then be shown in a main stream (likely homepage). When content is positively voted (“pumped up”) past a threshold (set by algorithm), publishers can opt to have their identity revealed and share their content on various social media platforms

### CROSS-REFERENCE TO RELATED APPLICATIONS

This application claims the benefit of U.S. Provisional Patent Application No. 61/698,298, filed on Sep. 7, 2012, entitled “APPARATUS, SYSTEM, AND METHOD FOR ANONYMOUS SHARING AND PUBLIC VETTING OF CONTENT” and U.S. Provisional Patent Application No. 61/699,043, filed on Sep. 10, 2012, entitled “SMART IMAGE DISPLAY,” each of which is incorporated herein by reference in its entirety.

The present disclosure is related generally to a computing platform and techniques for anonymous sharing and public vetting of content. More particularly, the present disclosure is related to a computing platform and techniques for anonymous sharing and public vetting of ideas and creative content. More specifically, the present disclosure is related to a computing platform and techniques for anonymous sharing and public vetting of ideas and creative content distributed over wide area networks, such as social networks accessible over the Internet, for sharing messages, ideas, and creative content between users.

Conventional social networks have become a preeminent tool for the communication and sharing of messages, ideas, and creative content. Despite recent advances, conventional social media platforms are selfish, limiting, and repetitive. While many people enjoy using these tools, security, privacy concerns, and overall anxiety keep some users/members from publishing content. There are a large number of factors causing this anxiety, but a commonly cited reason for not posting potential content is that it is “tied to one's name.” Those that share this concern are often worried about their content not being “good” or “funny.” Other issues include “information overload” and a lack of content diversity due to a limited social graph.

Currently, there are no widely used, lightweight, and simple tools/applications that allow for anonymous sharing and the public vetting of ideas and content, including creative content. Additionally, internet users face continuing information overload and a limited selection of content to view (due to current social media limitations organized by social graph). These problems are intended to be resolved by the following disclosure related to an apparatus, system, and method for anonymous sharing and public vetting of content, which may be referred to throughout the present disclosure as baloonr.

### SUMMARY

Various embodiments of the present disclosure are directed generally to an anonymous content publishing and distribution platform for anonymous sharing and public vetting of content.

In another embodiment, the present disclosure is directed generally to an anonymous content publishing and distribution method for anonymous sharing and public vetting of content.

In another embodiment, the present disclosure is directed generally to an anonymous content publishing and distribution system for anonymous sharing and public vetting of content.

In one embodiment, directed generally to an anonymous content publishing and distribution, an apparatus, system, and method for anonymous sharing and public vetting of content provides that posts will not display any of the identifiable publisher's information, but may include non-identifiable information, such as posting date. The apparatus, system, and method will enable the public to vote (both positively and negatively) on individual posts, with the resulting vote information being visible only to the publisher. Top-ranked content will then be shown in a main stream (likely homepage). When content is positively voted (“pumped up”) past a threshold (set by algorithm), publishers can opt to have their identity revealed and share their content on various social media platforms.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

In one or more various aspects, related systems include but are not limited to circuitry and/or programming for effecting herein-referenced method aspects; the circuitry and/or programming can be virtually any combination of hardware, software, and/or firmware configured to effect the herein-referenced method aspects depending upon the design choices of the system designer. In addition to the foregoing, various other method and/or system aspects are set forth and described in the teachings such as text (e.g., claims and/or detailed description) and/or drawings of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### FIGURES

The novel features of the embodiments described herein are set forth with particularity in the appended claims. The embodiments, however, both as to organization and methods of operation may be better understood by reference to the following description, taken in conjunction with the accompanying drawings as follows.

FIG. 1 is a rendering of a user interface display screen illustrating features of a display for main content stream according to one embodiment.

FIG. 2 is a rendering of a user interface display screen illustrating features of a display for reviewing content according to one embodiment.

FIG. 3 is a rendering of a user interface display screen illustrating features of a profile display according to one embodiment.

FIG. 4 is user interface display screen illustrating a display of a home page according to one embodiment.

FIG. 5 is a user interface display screen illustrating a display for reviewing content according to one embodiment.

FIG. 6 is one embodiment of a flowchart of the overall process that will define one embodiment of a user-experience that are explained above.

FIG. 7 is one embodiment of a flowchart process to enable the users to review content (e.g., baloons).

FIG. 8 is one embodiment of a process to display a stream of content on a designated page (likely the homepage) once the content has received enough votes (hits threshold determined by algorithm).

FIG. 9 illustrates various embodiments of launcher prompts that may be displayed by the anonymous content publishing and distribution system.

FIG. 10 illustrates one embodiment of a smart image display that may be integrated with the anonymous content and publishing distribution platform.

FIG. 11 illustrates one embodiment of a computing device which can be used in one embodiment of an apparatus, system, and method to implement the various described embodiments for anonymous sharing and public vetting of content according to one embodiment.

### DESCRIPTION

Before explaining the various embodiments of the apparatus, system, and method for anonymous sharing and public vetting of content in detail, it should be noted that the various embodiments disclosed herein are not limited in their application or use to the details of construction and arrangement of parts illustrated in the accompanying drawings and description. Rather, the disclosed embodiments may be positioned or incorporated in other embodiments, variations and modifications thereof, and may be practiced or carried out in various ways. Accordingly, embodiments of the apparatus, system, and method for anonymous sharing and public vetting of content disclosed herein are illustrative in nature and are not meant to limit the scope or application thereof. Furthermore, unless otherwise indicated, the terms and expressions employed herein have been chosen for the purpose of describing the embodiments for the convenience of the reader and are not to limit the scope thereof. In addition, it should be understood that any one or more of the disclosed embodiments, expressions of embodiments, and/or examples thereof, can be combined with any one or more of the other disclosed embodiments, expressions of embodiments, and/or examples thereof, without limitation.

In the following description, reference is made to the accompanying drawings, which form a part hereof. In the drawings, similar symbols typically identify similar components, unless context dictates otherwise. The illustrative embodiments described in the description, drawings, and claims are not meant to be limiting. Other embodiments may be utilized, and other changes may be made, without departing from the scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will recognize that the various embodiments described herein can be implemented, individually and/or collectively, by various types of electronic systems having a wide range of electrical components such as hardware, software, firmware, and/or virtually any combination thereof; and a wide range of components. Consequently, as used herein “electronic system” includes, but is not limited to, electrical circuitry, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electronic systems may include, but are not limited to, a variety of consumer electronics systems, medical devices, as well as other systems such as motorized transport systems, factory automation systems, security systems, financial systems, regulatory systems, and/or communication/computing systems.

Those skilled in the art will further recognize that at least a portion of the devices and/or processes described herein can be integrated into a computer processing system. A typical computer processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops. A computer processing system may be implemented utilizing suitable commercially available components.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

According to various embodiments, the present disclosure is related generally to techniques for anonymous sharing and public vetting of content. More particularly, the present disclosure is related to techniques for anonymous sharing and public vetting of ideas and creative content. More specifically, the present disclosure is related to techniques for anonymous sharing and public vetting of ideas and creative content distributed over wide area networks, such as social networks accessible over the Internet, for sharing messages, ideas, and creative content between users.

In accordance with various embodiments, posts will not display any of the identifiable publisher's information, but may include non-identifiable publisher information, such as the posting date, the system for anonymous sharing and public vetting of content (e.g., balloons) enables the public to vote (both positively and negatively) on individual posts, with the resulting vote information only visible to the publisher. Top-ranked content will then be shown in a main stream (likely homepage). When content is positively voted (“pumped up”) past a threshold (set by algorithm), publishers can opt to have their identity revealed and share their content on various social media platforms. In some embodiments, the anonymous content publishing and distribution system and methods are configured to provide unique, user generated content and to provide democratized content virality to enable sharing of creative and other content.

In one embodiment, the user-facing interface will be available via a website and mobile application/website.

Definition of Terms

baloon—a posted piece of content (e.g., idea, photo, image, file, text) and/or a displayed container containing the posted piece of content. Although the term baloon is used herein to refer to a posted piece of content and/or a displayed container for the content, those skilled in the art will recognize that any displayed container may be used to display the content to a user/reviewer.

Pump It—a positive vote for content

Pop It—a negative vote for content

Taking Off—content that has been “pumped-up” enough times to hit a threshold (set by algorithm) in order for it to appear in the main content stream. This is the point when the content is free to be shared (via 3^{rd} party networks, email, etc.) and the publisher can claim ownership of the content.

Definition of User Types

The computing platform for anonymous sharing and public vetting of content employs several user types such as, for example, (1) Unauthenticated User, (2) Authenticated User Publisher, (3) Authenticated User Reviewer, (4) Scouts, although the embodiments are not limited as such. These several user types are defined hereinbelow.

An “Unauthenticated User” (Free) is a public user type that is not logged-in and can only view live stream of top content on a home page. The “Unauthenticated User” is able to search by category and tags on the home page and is able to share content via social media. The benefits of being an “Unauthenticated User” include but are not limited to being able to view vetted (highest-ranked) content/baloons and share the vetted content on social media sites. Since content is not limited to that within a user's social graph, the users have access to content BEYOND what is shared with them from friends, randomization, expansion of knowledge, and/or exposure. The “Unauthenticated User” has exposure to the site, process, and influence of publishing.

A second user type is an “Authenticated User: Publisher” (Free). This user type is a logged-in account holder who might pay for additional features/categories. In some embodiments, the “Authenticated User: Publisher” uses a free model and is able to post/publish content to be reviewed. In other embodiments, the “Authenticated User: Publisher” uses another model, such as, for example, a “freemium” model. The benefits of an “Authenticated User: Publisher” include but are not limited to anonymity (user name not linked to the content until it reaches a certain level of fullness) and has the ability to vet ideas and content. Success of an idea is NOT dependent on social graph, as the content receives random reviews. The “Authenticated User: Publisher” has an opportunity to get scouted and recognized for great content, for example. In connection with the number of baloons (e.g., successful content posted by the user) that have taken off and are about to be shared and marketed the “Authenticated User: Publisher” will receive an email with links to share on social media outlets: “I had a baloon and others thought that it should take off, so over XXXXXX people pumped it up. Check it out here.”

Those skilled in the art will appreciate that the term “freemium” refers to a business model that combines free products or services with premium products or services that are not free. A product or service is typically a digital offering such as software, media, games, web services. The product or service is provided free of charge, but a premium is charged for advanced features, functionality, or virtual goods.

Another type of user is an “Authenticated User: Reviewer” (Free). This type of user is a logged-in account holder that might pay for additional features/categories using the “freemium” model. In other embodiments, the additional features/categories may be provided free. Functionality associated with an “Authenticated User: Reviewer” is the ability to post/publish content to be reviewed and to review content by ranking it using the “pop it” or “pump it up” functional features. The user can default on random review of content, and in another embodiment also may be able to select content/categories to review. The percentage (%) of pumped content that has taken off will be tracked and included with the user account. If there is a high percentage of pumped content, the user will be able to gain ability to specify categories or view more heavily vetted content (i.e., higher quality).

The benefits of an “Authenticated User: Reviewer” include but are not limited to low to no level of effort (LOE) required for logging-in and ability to scroll through content. Additionally, an “Authenticated User: Reviewer” has expansive entertainment benefits beyond what is shared by friends or contacts on other social media sites and exposure to images, ideas, content from individuals beyond group of contacts. For example, one aspect of the game of percentage (%) associated with the user is the percentage (%) of the amount of reviewed content that has taken off that the reviewer pumped up—the reviewer will receive an email with a link to share on social media sites: “I pumped up this baloon. Now, it's taking off. Check it out here.” The email also may include something about: “I was one of a million molecules of air that pumped up this baloon. Now, it's flying into the universe. Check it out here.” Creative, fun, and unique messages to share on other sites will drive visitors to the platform. Other benefits of the “Authenticated User: Reviewer” include but are not limited to the opportunity for the user to be recognized for talents in reviewing/scouting measured by the percentage (%) of the user content pumped up that has taken off and the opportunity to directly influence what goes viral in the world - immediate random interaction. The system is able to share percentage through social media sites as well.

Other user types include Scouts. Scouts are pay users with individual and corporate options (# of accounts per organization). The Scouts receive an advance notice (24 hours or some short) timeframe to review top content right before it takes off. Scouts have the ability to contact, privately, only through site, users with top content and can potentially bid for initial contact with publishers of top content that can be incorporated into the pay model.

Scouts users enjoy benefits that include but are not limited to a first look at vetted content, which saves time and resources. Scouts are exposed to new talent pools through non-traditional channels.

Description of the User Interface

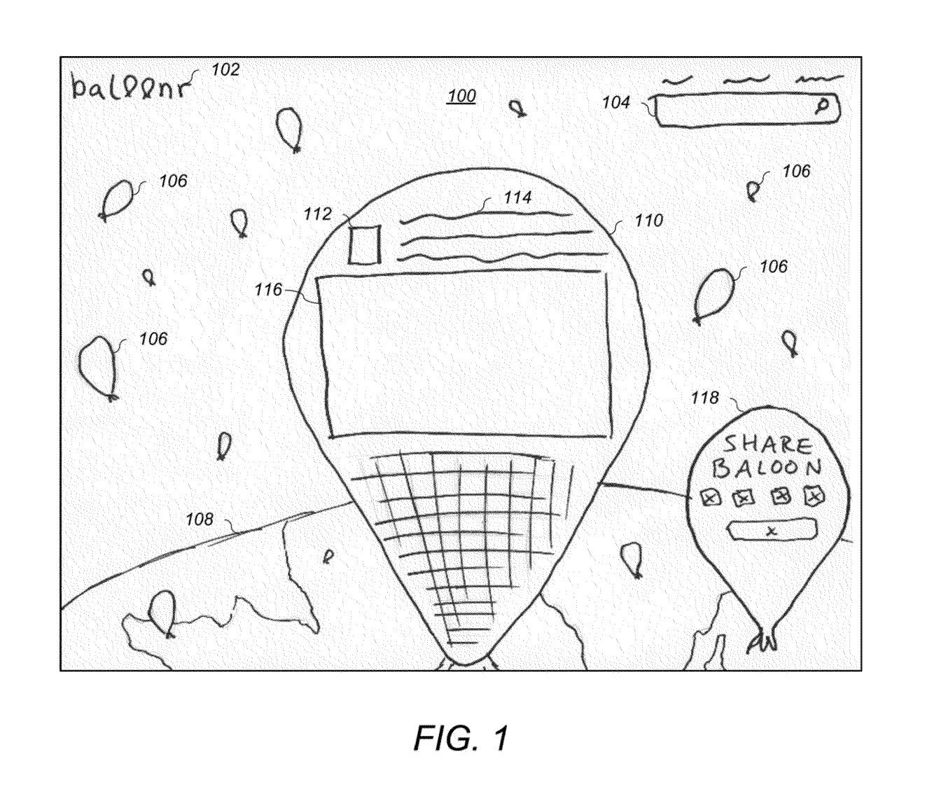

FIG. 1 is a rendering of a user interface display screen 100 illustrating features of a display for main content stream according to one embodiment. In one embodiment, the main user interface display screen 100 includes certain universal elements. For example, a user interface display screen includes a platform logo 102 where two balloons are used in place of “o's” to link to the homepage. This link may be provided at the upper left-hand portion (corner) of the user interface display screen 100, for example. A search bar 104 for users to search categories and tags that people add also is included in the user interface display screen 100. Other elements of the main user interface display screen 100 include utility links, such as, for example, Help, Sign-Up, Log-In may be provided at the top right-hand portion (corner) of the user interface display screen, for example.

The content of the main user interface display screen 100 also includes, without limitation, an animation area where content containers 106 (for example, graphical baloons) rise up the main screen 100 continuously and then fade into the distance. A globe 108 rises up spins, stops on a side of the world, and zooms in. After zooming in, the main content container 110 rises up toward the main screen 100. Little images 112 of the reviewers' photos that make up the content container 110 are shown. Text by content 114 may include a phrase such as, for example: “Username's baloon took off because X users (include detailed breakdown of gender, demographic, content) reviewed it and pumped it up.” Scrolling over the Username provides the number of submitted content container 110 items that have taken off and percentage reviewed. The user has the ability to select “anonymous option” or to allow individuals to select username profile and visit. The content container 110 also includes a main display area 116 and a share content container 118.

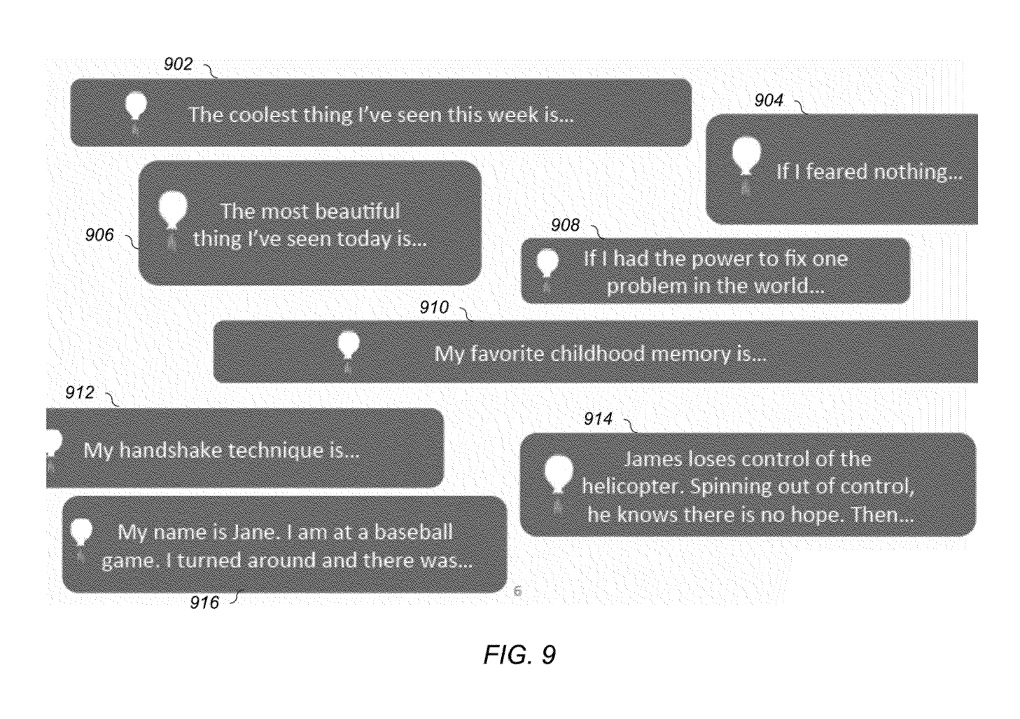

In some embodiments, the main user interface display screen 100 may display a launcher prompt. The user may interact with the launcher to generate content based on the launcher. The launcher may provide a specific prompt for the type of content to be provided. For example, a launcher may prompt a user to provide a specific type of content such as: “The funniest thing I saw today was . . . ” or “Humans are hopeful, resilient creatures. Give an example.” The tone, type, and/or content of a launcher may be varied based on one or more factors. For example, one or more launchers may be funny, serious, single-word prompts, phrases, and/or traditional writing prompts. A launcher provides the user with a starting point for the generation of content. FIG. 9 illustrates various embodiments of launchers.

In some embodiments, the main user interface display screen 100 includes native advertising. Native advertising provides advertising integrated into the main user interface display screen 100. For example, a brand, company, and/or organization may sponsor a launcher connected to and/or to promote the brand, company, and/or organization. For example, the “Nerds” brand may sponsor a launcher that states “I knew I was a nerd when . . . ” which encourages users to generate content relating the brand “Nerds” and incorporating the brand name into the content. The brand, company, and/or organization receives increased traffic, visibility, and engagement with customers, such as, for example, creative engagement. The computing platform may charge the sponsoring brand a fee based on the number of content responses submitted to the brand's launcher through the sponsored launcher. The fees charged may be based on a tiered level system with the tiers corresponding to, for example, the number of users who submit content to the brand's launcher.

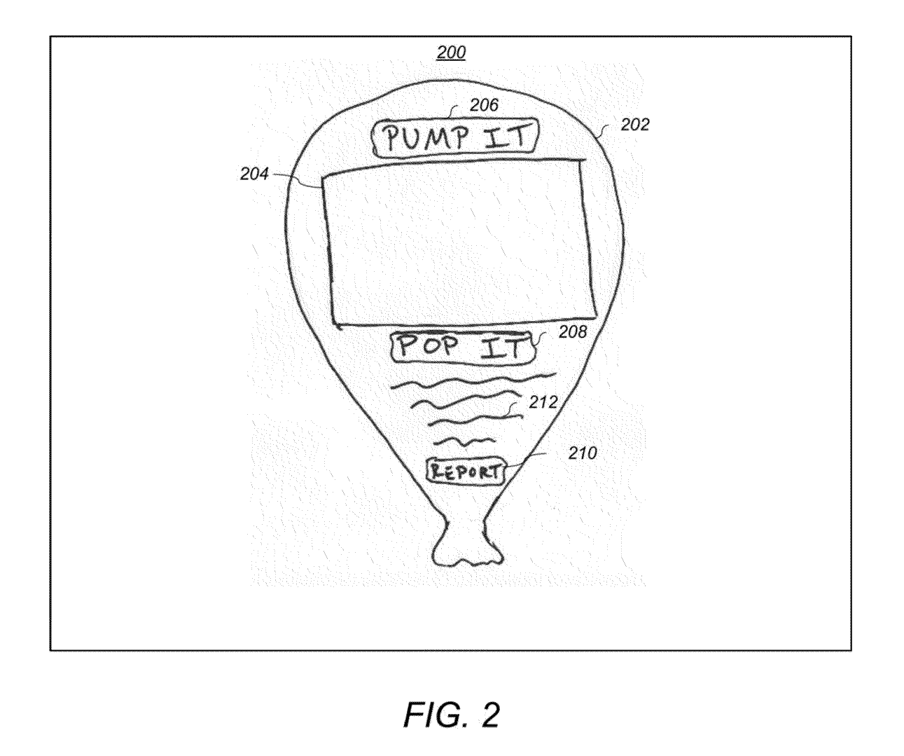

FIG. 2 is a rendering of a user interface display screen 200 illustrating features of a display for reviewing content in a content container 202 according to one embodiment. The reviewer page elements shown on the review user interface display screen 200 include but are not limited to a content container 202 having a message area 204. A first box 206 above the message area 204 includes a virtual button with text such as, for example, “Pump It Up” or “Pump” or “Pump It” to pump up the content 202. A second box 208 below the message area 204 includes a second virtual button with text, such as, “Pop” or “Pop It” to pop the content 202. Also below the message area 204 and the second box 208 is a virtual button 210 to report the post for spam, inappropriate content, or incorrectly categorized content. A text area 212 is provided to indicate when content was submitted and where it originated.

In some embodiments, the content container 202 may comprise a comment area (not shown). The comment area allows a reviewer to leave an anonymous comment regarding the content of the content container 202. For example, a reviewer may provide a reason for why the user decided to pump or pop the content 202. As another example, a reviewer may provide information for helping the content submitter to improve the quality of future posts. The comments are provided to the content submitter to provide the submitter with feedback regarding the posted content. In some embodiments, reviewer comments are displayed with the content container in the main content stream, for example, on the homepage.

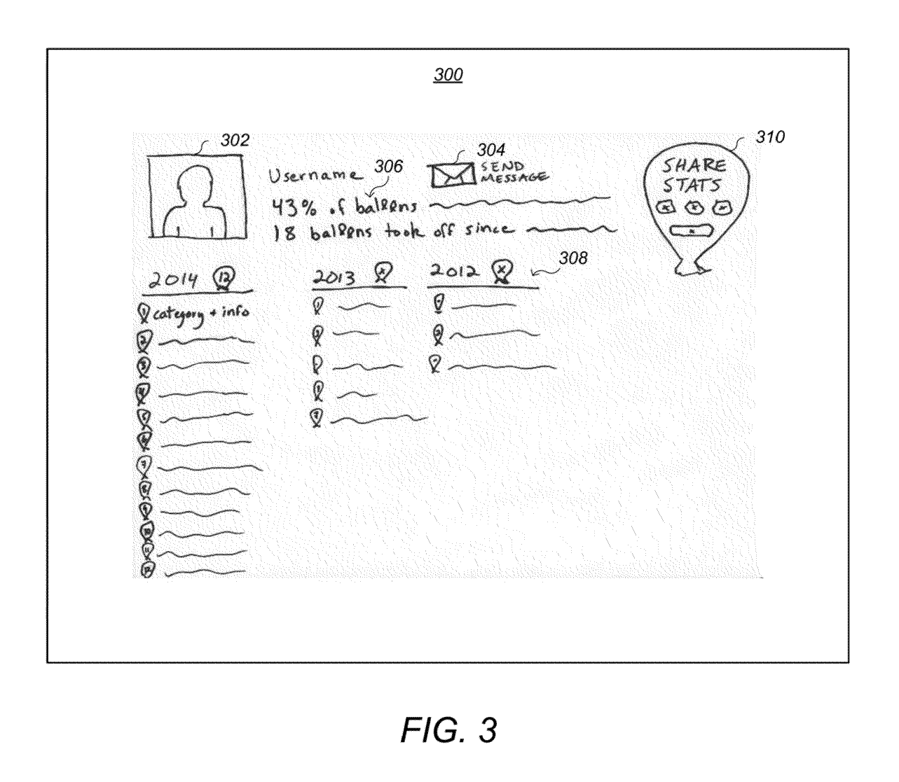

FIG. 3 is a rendering of a user interface display screen 300 illustrating features of a profile display according to one embodiment. The profile display user interface display screen 300 includes, without limitation, a profile pic/avatar/graphic 302 and a send message button 304. The communication system associated with the profile display user interface display screen 300 does not display any contact info. Also displayed are statistics 306 such as percentage of submitted content that “took off” and number per year 308. An option to share statistics 310 from the user's own profile also is displayed.

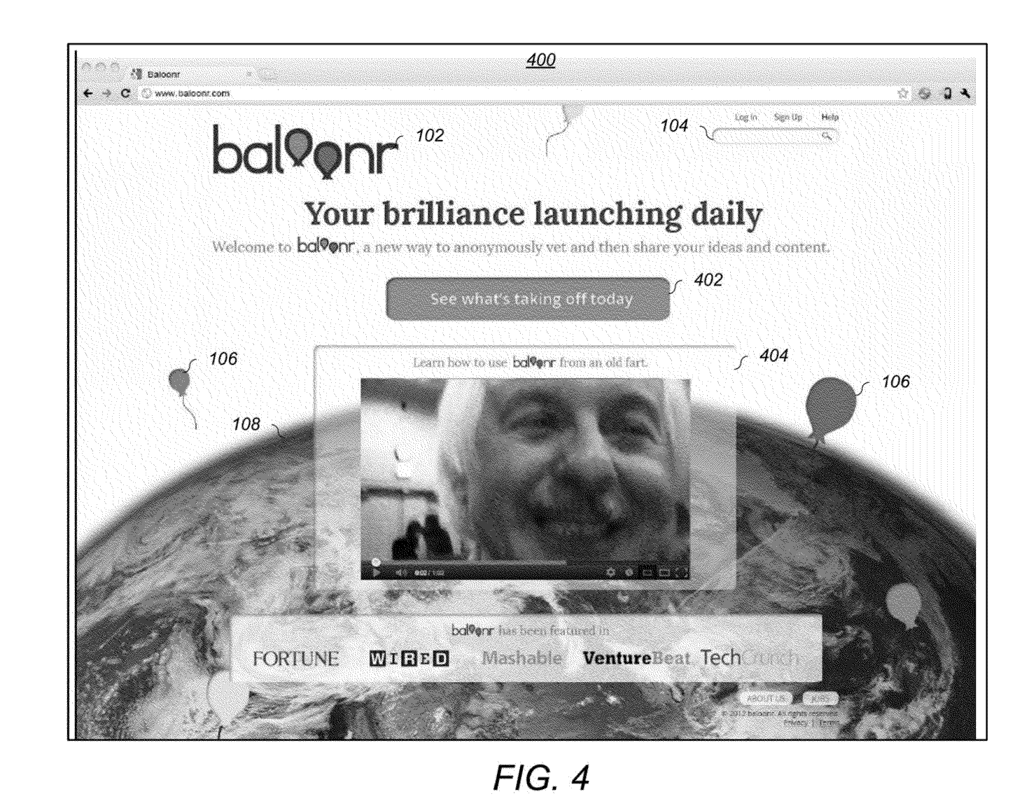

FIG. 4 is a user interface display screen 400 illustrating a display of a home page according to one embodiment. The home page user interface display screen 400 may include additional buttons such as, for example, View Today's content 402, learn more 404, among other elements. The home page user interface display screen 400 includes a platform logo 102 where two balloons are used in place of “o's” to link to the homepage. This link may be provided at the upper left-hand portion (corner) of the user interface display screen, for example. A search bar 104 for users to search categories and tags that people add also is included in the user interface display screen 400. Other elements of the user interface display screen 400 include utility links, such as, for example, Help, Sign-Up, Log-In may be provided at the top right-hand portion (corner) of the user interface display screen, for example.

In one embodiment, the user interface display screen 400 may include, without limitation, content containers 106 rising up the screen 400 continuously and then fading into the distance. A globe 108 rises up, spins, stops on a side of the world, and then zooms in. After zooming in, the main content container 202 rises up toward the screen 400.

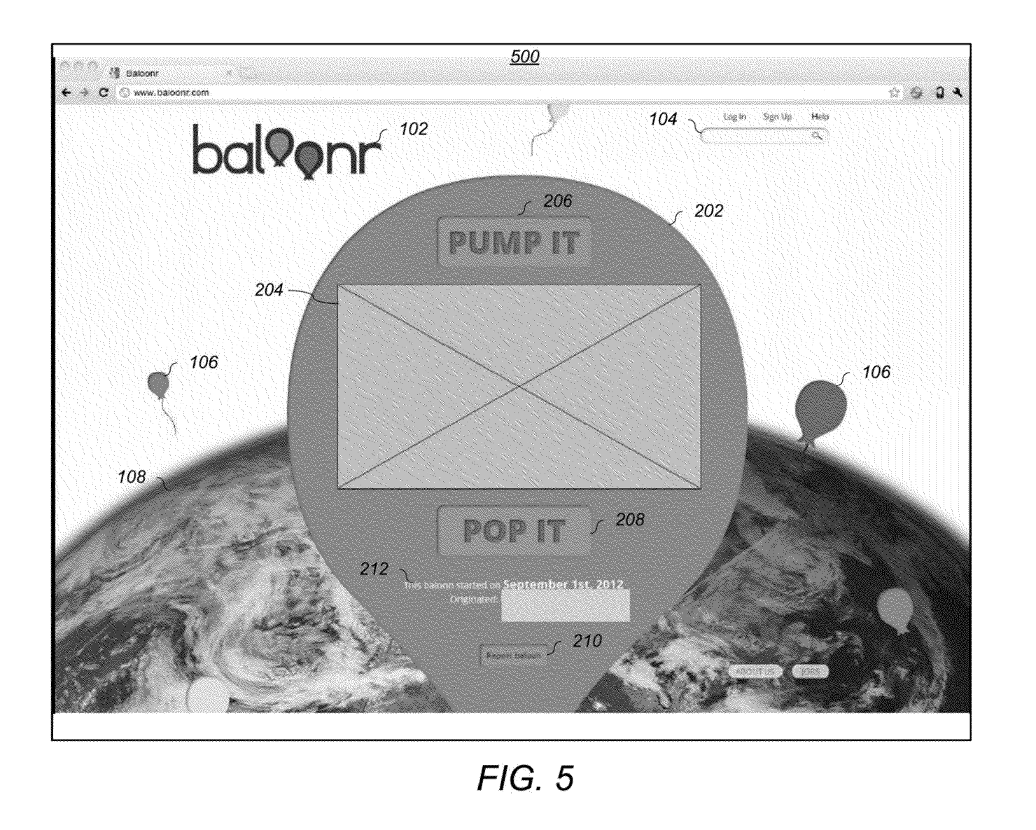

FIG. 5 is a user interface display screen 500 illustrating a display for reviewing content according to one embodiment. The reviewer page elements shown on the review user interface display screen 500 include but are not limited to a content container 202 having a message area 204. A first box 206 above the message area 204 includes a virtual button with text such as, for example, “Pump It Up” or “Pump” or “Pump It” to pump up the content 202. A second box 208 below the message area 204 includes a second virtual button with text, such as, “Pop” or “Pop It” to pop the content 202. Also below the message area 204 and the second box 208 is a virtual button 210 to report the post for spam, inappropriate content, or incorrectly categorized content. A text area 212 is provided to indicate when content was submitted and where it originated.

In one embodiment, the review user interface display screen 500 may include, without limitation, content containers 106 rising up the screen 400 continuously and then fading into the distance. A globe 108 rises up, spins, stops on a side of the world, and then zooms in. After zooming in, the main content container 202 rises up toward the screen 400.

With reference now to FIGS. 1-5, an anonymous content publishing and distribution computing platform (balloons) is discussed. As will be appreciated by those skilled in the art, a computing platform includes a hardware architecture and a software framework (including application frameworks), where the combination allows software, particularly application software, to run. Typical platforms include a computer's architecture, operating system, programming languages, and related user interface (run-time system libraries or graphical user interface). In one embodiment, the computing platform provides users freedom from the worry of social criticism and potential ridicule that can accompany posting content associated with one's name and personal/professional profile. In one embodiment, the platform also separates the success of a post from a user's social graph, “leveling the playing field” and democratizing content creation. Users are presented with the unique opportunity to anonymously vet their content and ideas before this content enters a public space/domain, allowing users to refine their content and better determine what connects with others and what is their “best” content.

A user can anonymously post content (e.g., photo, video, poetry) to be reviewed by other users. A user posts their content 202 in one of the provided categories and then “tag” their content with keywords (potentially a limited number) that further describe the content of their content container 202. Reviewers can choose to either “pump” up a content container 202 (if they like it) or “pop” a content container 202 (if they do not like it). If a content container 202 gets “pumped” up by enough users, it “takes off,” appears on the home page 100, 400 (likely location), and is available/encouraged to be shared through other social media websites (e.g., Facebook, Twitter). The content container 110 on the home page 100 also includes information about the number of people who “pumped” it up (causing it to take off) and may include demographic information about the reviewing audience (e.g., from this many countries, these age categories). At this point, a user may remove the anonymity feature and link the content 110 to the user's username and profile.

When posted on the home page 100, 400 all reviewers of that specific content 110 will receive a notification informing them that a content container 202 that they reviewed (and either pumped or popped) has “taken off.” Reviewers are presented with an opportunity to share the content 202 (and additional information that they reviewed it before it took off) through their other social media sites and profiles. The creator will also receive a notification informing them that the content 110 that they created has taken off.

In order to review content 202, users will need to create an account. The platform aims to not only recognize top content, but also to acknowledge the talent that comes with being able to recognize top content/talent.

The purpose of the platform is not to highlight profiles, but rather, to highlight the top, heavily vetted and reviewed, content. With that in mind, the content contained in the profiles will be kept to a minimum. Information will be focused on the content 110 created and statistics related to them taking off. Users will be provided with a mechanism to share their own statistics across social media networks. The platform will also incorporate an internal messaging or communication system so that publishers (and reviewers) can be contacted while maintaining their anonymity.

Since the main stream of content 110 is based on quality, and not based on the publisher's popularity, the platform provides an opportunity for talent scouting and recruiting. In one embodiment, additional premium functionality may be provided for Scouts, allowing the Scouts to view top content prior to content containers 110 “taking off.” The Scouts also will have early access to communication with content publishers (and reviewers). This will provide beneficial opportunities for employers, job seekers, collaborators, and others seeking talent.

As the platform grows and matures the functionality will become more robust. The platform's search feature will become an idea and content search engine in itself. More options for tagging and categorizing will help the organizational structure of the content while allowing the search feature to find better and more relevant content 110 for users. External search engines will only index content 110 that has already “taken off.”

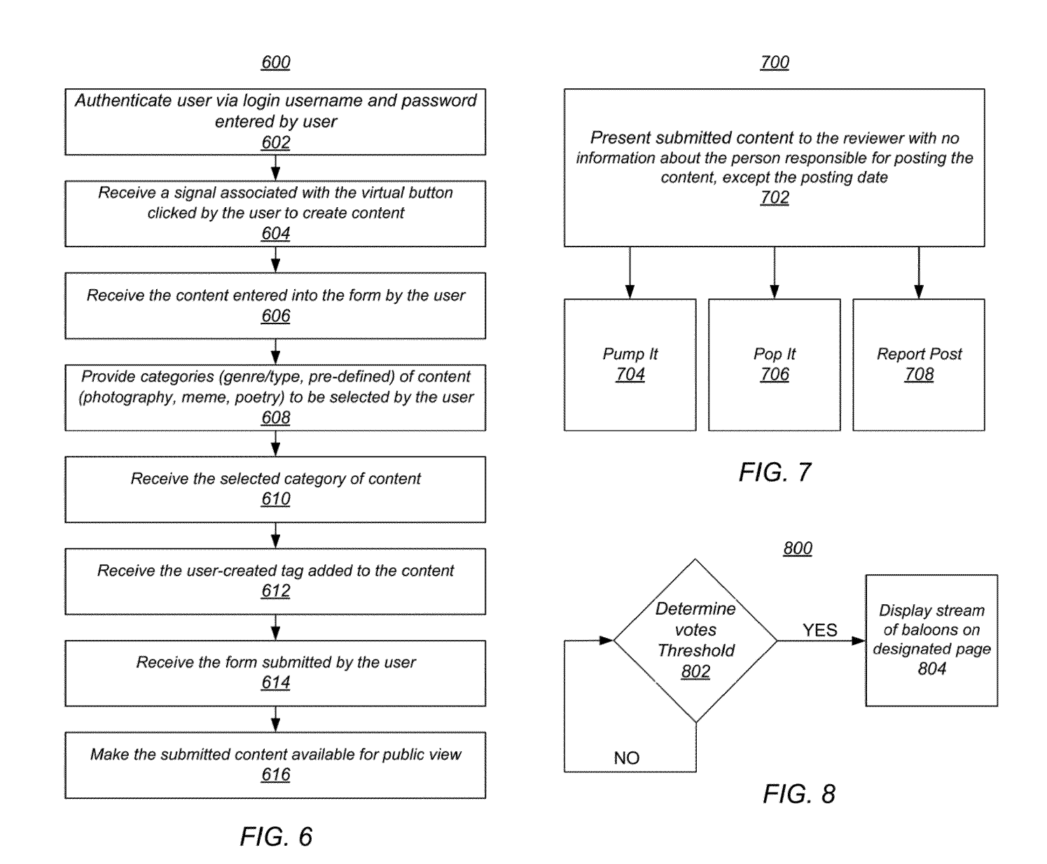

FIG. 6 is one embodiment of a flowchart 600 of the overall process that defines one embodiment of a user-experience explained above. In one example, the overall information flow for the anonymous sharing and public vetting of content (e.g., balloons), where the platform receives from a user content to be vetted by the public without any of the publisher's personal information being revealed, includes but is not limited to the following process.

The user authenticates via log-in with username and password and at 602 the platform authenticates the user via log-in username and password entered by the user. The user then clicks on a virtual button to create content. At 604, the platform receives a signal associated with the virtual button clicked by the user to create content. The user then enters content into a form (text and/or file) and at 606 the platform receives the content entered into the form by the user. At 608, the platform provides categories (genre/type, pre-defined) of content (e.g., photography, meme, poetry) that may be selected by the user. When the user selects a category (genre/type, pre-defined) of content (e.g., photography, meme, poetry), at 610, the platform receives the selected category of content. The user can add user-created tags to the content to allow for similar content to be easily found. Accordingly, at 612, the platform also receives the user-created tags added to the content. At 614, the platform receives the form submitted to the platform by the user and at 616 the platform makes the submitted content (a baloon) available for public review.

FIG. 7 is one embodiment of a flowchart 700 process to enable the users to review the content. At 702, submitted content is presented to the reviewer by the platform with no information about the person responsible for posting the content, except the posting date. The platform provides options for the reviewer to “Pump It” 704 to increase a post's ranking, “Pop It” 706 to decrease a post's ranking, and report the post 708 (for spam, inappropriate content, or incorrectly categorized content).

FIG. 8 is one embodiment of a flowchart 800 process to display a stream of content on a designated page (likely the homepage) once the content has received enough votes (hits threshold determined by algorithm). At decision block 802, the platform determines whether the votes received by the content exceed and/or are equal to a predetermined threshold. When the number of votes exceeds and/or is equal to the predetermined threshold, the process proceeds along YES path to 804 to display a stream of content on a designated page. If the number of votes does not exceed and/or is not equal to the predetermined threshold, the process continues along NO path back to the decision block 802 to continue testing the threshold of votes received by the content.

In any of the embodiments of the anonymous content publishing and distribution platform, the content creator has options to reveal their identity, share the content to other networks, and/or add an endorsement decal to their content.

FIG. 9 illustrates various embodiments of launcher prompts that may be presented to the user. As discussed above, a user may interact with a launcher to generate content based on the launcher. The launcher may provide a specific prompt for the type of content to be provided. The tone, type, and/or content of a launcher may be varied based on one or more factors. FIG. 9 illustrates various embodiments of the launchers that may be displayed to a user. In the illustrated embodiment, the launchers 902-916 comprise text prompts. However, those skilled in the art will recognize that other launchers, such as, for example, image, video, and/or audio launchers may be provided to the user.

In some embodiments, an individual deployment of the anonymous content and publishing distribution platform is generated for a specific business, organization, and/or government agency. The individual deployments include custom launchers targeted to business goals, projects, tasks, and/or other internal prompts. The individual deployment of the anonymous content and publishing distribution platform solicits content from the organization's employees/members, and allows those employees/members to provide content in an anonymous and distributed platform. Individual deployment of the anonymous content and publishing distribution platform will help to stimulate creativity in the workplace, which is currently underserved. Thirty-two percent (32%) of working professionals do not feel comfortable thinking creatively in their career and seventy-eight percent (78%) wish they had more creative ability. An individual deployment of the anonymous content and publishing distribution platform allows employees to think creatively and be more creative while remaining anonymous unless and until an idea is positively reviewed by the employees peers.

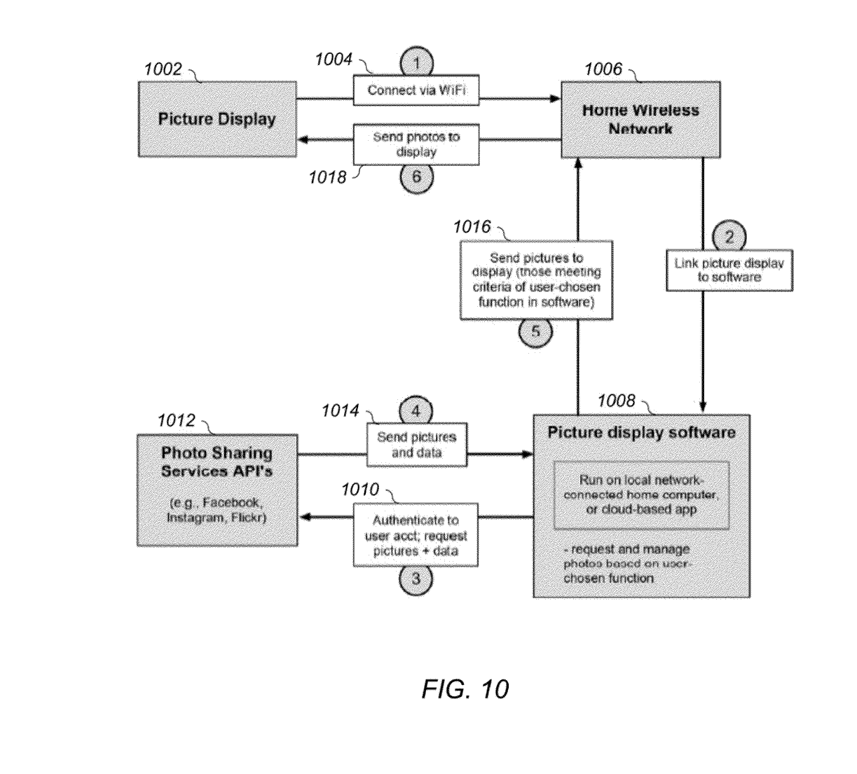

FIG. 10 illustrates one embodiment of a smart image display 1000 that may be integrated with the anonymous content and publishing distribution platform. The smart image display applies to both the unique hardware used and the process by which the hardware displays certain images. A smart image display 1002 (typically referred to as a “picture frame”) would be wifi enabled to allow for wireless syncing 1004 of images. The smart image display 1002 connects through a home network 1006 to picture display software 1008. The picture display software 1008 runs on a local network-connected computer and/or as a cloud-based application. The picture display software 1008 is configured to request and manage photos based on user-selected functions. The picture display software 1008 connects and authenticates 1010 with photo sharing services 1012. The photo sharing services 1012 comprise application programming interfaces (APIs) for interacting with the photo sharing services 1012. The photo sharing services 1012 transmit pictures and data 1014 to the picture display software 1008. The picture display software 1008 selects 1016 photos matching user-defined criteria and provides the pictures matching the user-defined criteria to the smart image display 1002 through 1018 the home network 1014. The image display 1002 uses photos from various sources (e.g., Facebook, Flickr, Instagram, Twitter) based on certain view modes, such as, for example, a calendar event-based display that syncs photos based on calendar events. For example Mary is visiting Amanda. This event is on Amanda's web-connected calendar (e.g., Google Cal, iCal, Exchange), which is accessible via API. Software retrieves photos of Amanda and Mary from photo sharing services (e.g., Flickr, Facebook). Photos of Amanda and Mary would be displayed within time range of the visit (or during self-selected dates). Another view mode comprises calendar date history-based display, which uses a similar process to calender event-based display, with the image display 1002 displaying photos from the current date in history. An example of this type of functionality would be showing seasonal photos or birthdays. Another view mode comprises a holiday/Event (e.g., anniversary, birthdays) based display. The holiday/event based view mode displays photos from around a given holiday (or date or timeframe). For example, one could display winter holiday photos from years past during the current holiday season. Since software would utilize APIs to access data from cloud-based services and serve images to display via wireless network, photos and calendar would not need to be stored on display or local computer. Multiple displays could be connected in a network of smart image displays. The software would be able to coordinate the images sent to the displays throughout the network. The smart image display provides online content to a decorating space. A user's life online is displayed in the user's physical environment (not just on the user's computer screen). For example, when spring (the season) arrives, numerous image displays throughout the home/office could be used to show spring imagery, such as flowers or wildlife (whatever any individual wants to feature based on their interests or decorative tastes). This could also result in an online community with photos for different decorative tastes, seasons, holidays, rooms, etc. Automated functionality can be scaled up or down, requiring the user to have as little or as much input as they desire.

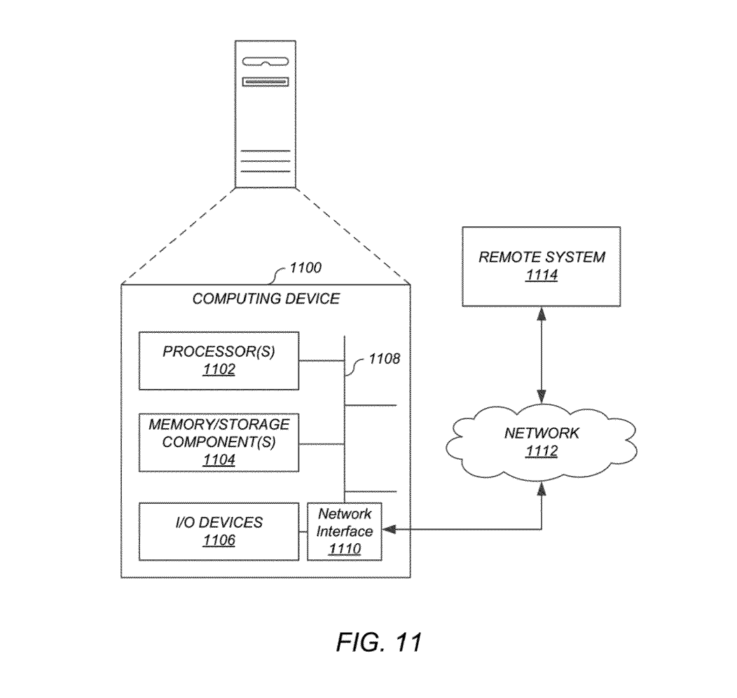

FIG. 11 illustrates one embodiment of a computing device 1100 which can be used in one embodiment of an apparatus, system, and method to implement the various described embodiments for anonymous sharing and public vetting of content according to one embodiment. The computing device 1100 may be employed to implement one or more of the computing devices, such as a mobile product service application in a system for real time delivery of context based information in a healthcare application according to the disclosed embodiments or any other suitably configured computing device. For the sake of clarity, the computing device 1100 is illustrated and described here in the context of a single computing device. It is to be appreciated and understood, however, that any number of suitably configured computing devices can be used to implement any of the described embodiments. For example, in at least some implementations, multiple communicatively linked computing devices are used. One or more of these devices can be communicatively linked in any suitable way such as via one or more networks 1112. One or more networks 1112 can include, without limitation: the Internet, one or more local area networks (LANs), one or more wide area networks (WANs) or any combination thereof.

In this example, the computing device 1100 comprises one or more processor circuits or processing units 1102, one or more memory circuits and/or storage circuit component(s) 1104 and one or more input/output (I/O) circuit devices 1106. Additionally, the computing device 1100 comprises a bus 1108 that allows the various circuit components and devices to communicate with one another. The bus 1108 represents one or more of any of several types of bus structures, including a memory bus or memory controller, a peripheral bus, an accelerated graphics port, and a processor or local bus using any of a variety of bus architectures. The bus 1108 may comprise wired and/or wireless buses.

The processing unit 1102 may be responsible for executing various software programs such as system programs, applications programs, and/or modules to provide computing and processing operations for the computing device 1100. The processing unit 1102 may be responsible for performing various voice and data communications operations for the computing device 1100 such as transmitting and receiving voice and data information over one or more wired or wireless communications channels. Although the processing unit 1102 of the computing device 1100 includes single processor architecture as shown, it may be appreciated that the computing device 1100 may use any suitable processor architecture and/or any suitable number of processors in accordance with the described embodiments. In one embodiment, the processing unit 1102 may be implemented using a single integrated processor.

The processing unit 1102 may be implemented as a host central processing unit (CPU) using any suitable processor circuit or logic device (circuit), such as a as a general purpose processor and/or a state machine. The processing unit 1102 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 2002 may be coupled to the memory and/or storage component(s) 1104 through the bus 1108. The memory bus 2008 may comprise any suitable interface and/or bus architecture for allowing the processing unit 1102 to access the memory and/or storage component(s) 1104. Although the memory and/or storage component(s) 1104 may be shown as being separate from the processing unit 1102 for purposes of illustration, it is worthy to note that in various embodiments some portion or the entire memory and/or storage component(s) 1104 may be included on the same integrated circuit as the processing unit 1102. Alternatively, some portion or the entire memory and/or storage component(s) 1104 may be disposed on an integrated circuit or other medium (e.g., hard disk drive) external to the integrated circuit of the processing unit 1102. In various embodiments, the computing device 1100 may comprise an expansion slot to support a multimedia and/or memory card, for example.

The memory and/or storage component(s) 1104 represent one or more computer-readable media. The memory and/or storage component(s) 1104 may be implemented using any computer-readable media capable of storing data such as volatile or non-volatile memory, removable or non-removable memory, erasable or non-erasable memory, writeable or re-writeable memory, and so forth. The memory and/or storage component(s) 1104 may comprise volatile media (e.g., random access memory (RAM)) and/or nonvolatile media (e.g., read only memory (ROM), Flash memory, optical disks, magnetic disks and the like). The memory and/or storage component(s) 1104 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1106 allow a user to enter commands and information to the computing device 1100, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The computing device 1100 may comprise an alphanumeric keypad coupled to the processing unit 1102. The keypad may comprise, for example, a QWERTY key layout and an integrated number dial pad. The computing device 1100 may comprise a display coupled to the processing unit 1102. The display may comprise any suitable visual interface for displaying content to a user of the computing device 1100. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1102 may be arranged to provide processing or computing resources to the computing device 1100. For example, the processing unit 1102 may be responsible for executing various software programs including system programs such as operating system (OS) and application programs. System programs generally may assist in the running of the computing device 1100 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple OS or other suitable OS in accordance with the described embodiments. The computing device 1100 may comprise other system programs such as device drivers, programming tools, utility programs, software libraries, application programming interfaces (APIs), and so forth.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices 1114 that are linked through a communications network 1112. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

While various details have been set forth in the foregoing description, it will be appreciated that the various embodiments of the apparatus, system, and method for anonymous sharing and public vetting of content may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the foregoing discussion, it is appreciated that, throughout the foregoing description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Some or all of the embodiments described herein may generally comprise technologies which can be implemented, individually, and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Various aspects of the subject matter described herein are set out in the following numbered clauses:

1. An apparatus comprising: a processor; and a non-transitory computer-readable medium coupled to the processor, the non-transitory computer-readable medium configured to store computer program instructions that when executed by the processor are operable to cause the processor to: receive content; provide the received content to one or more reviewers; receive a content rating from the one or more reviewers; aggregate the content ratings from the one or more reviewers; and adding the content to a main content stream when the aggregate content rating of the content exceeds a predetermined threshold.

2. The apparatus of clause 1, wherein the content is provided to the one or more reviewers anonymously.

3. The apparatus of clause 2, wherein the processor is further operable to provide non-user identifying information with the content.

4. The apparatus of clause 2, wherein the content ratings comprise one of a positive rating or a negative rating.

5. The apparatus of clause 2, wherein the processor is further operable to: receive an indication that a user wishes to be associated with the content; associate identifying information with the content to identify the user; and provide the identifying information with the content in the main content stream.

6. The apparatus of clause 2, wherein the processor is further operable to: generate a launcher comprising a content generation prompt; and receive content from the one or more users corresponding to the content generation prompt of the launcher.

7. The apparatus of clause 5, wherein the processor is further operable to: calculate a total content amount received in response to the launcher; and calculate a fee for an advertising partner based on the total content amount received.

8. The apparatus of clause 2, wherein the processor is further operable to transmit the content to a social media partner when the aggregate content rating of the content exceeds the predetermined threshold.

9. The apparatus of clause 2, wherein the processor is further operable to: determine demographic information of the one or more reviewers; and provide the demographic information with the content in the main content stream.

10. A computer-implemented method comprising: receiving, by a processor, content; providing, by the processor, the received content to one or more reviewers; receiving, by the processor, a content rating from the one or more reviewers; aggregating, by the processor, the content ratings from the one or more reviewers; and adding, by the processor, the content to a main content stream when the aggregate content rating of the content exceeds a predetermined threshold.

11. The computer-implemented method of clause 9, comprising providing, by the processor, the content to the one or more reviewers anonymously.

12. The computer-implemented method of clause 11, comprising providing, by the processor, non-user identifying information with the content.

13. The computer-implemented method of clause 10, receiving, by the processor, content ratings comprising one of a positive rating or a negative rating.

14. The computer-implemented method of clause 10, comprising: receiving, by the processor an indication that a user wishes to be associated with the content; associating, by the processor, identifying information with the content to identify the user; and displaying, by the processor, the identifying information with the content in the main content stream.

15. The computer-implemented method of clause 10, comprising: generating, by the processor, a launcher comprising a content generation prompt; and receiving, by the processor, content from the one or more users corresponding to the content generation prompt of the launcher.

16. The computer-implemented method of clause 13, comprising: calculating, by the processor, a total content amount received in response to the launcher; and calculating, by the processor, a fee for an advertising partner based on the total content amount received.

17. The computer-implemented method of clause 10, comprising transmitting, by the processor, the content to a social media partner when the aggregate content rating of the content exceeds the predetermined threshold.

18. The computer-implemented method of clause 10, comprising: determining, by the processor, demographic information of the one or more reviewers; and providing, by the processor, the demographic information with the content in the main content stream.

19. An anonymous content publishing and distribution system for anonymous sharing and public vetting of content comprising: a processor; and a non-transitory computer-readable medium coupled to the processor, the non-transitory computer-readable medium configured to store computer program instructions that when executed by the processor are operable to cause the processor to: receive content from a user; provide the received content to one or more reviewers, wherein the content is displayed to the one or more reviewers anonymously; receive a content rating from the one or more reviewers, wherein the content ratings comprise one of a positive rating or a negative rating; aggregate the content ratings from the one or more reviewers; and add the content to a main content stream when the aggregate content rating of the content exceeds a predetermined threshold.

20. The anonymous content publishing and distribution system for anonymous sharing and public vetting of content of clause 19, wherein the processor is further operable to: generate a launcher comprising a content generation prompt; and receive content from the one or more users corresponding to the content generation prompt of the launcher.

1. An apparatus comprising:
a processor; and
a non-transitory computer-readable medium coupled to the processor, the non-transitory computer-readable medium configured to store computer program instructions that when executed by the processor are operable to cause the processor to:
receive content;
provide the received content to one or more reviewers;
receive a content rating from the one or more reviewers;
aggregate the content ratings from the one or more reviewers; and
adding the content to a main content stream when the aggregate content rating of the content exceeds a predetermined threshold.

2. The apparatus of claim 1, wherein the content is provided to the one or more reviewers anonymously.

3. The apparatus of claim 2, wherein the processor is further operable to provide non-user identifying information with the content.

4. The apparatus of claim 2, wherein the content ratings comprise one of a positive rating or a negative rating.

5. The apparatus of claim 2, wherein the processor is further operable to:
receive an indication that a user wishes to be associated with the content;
associate identifying information with the content to identify the user; and
provide the identifying information with the content in the main content stream.

6. The apparatus of claim 2, wherein the processor is further operable to:
generate a launcher comprising a content generation prompt; and
receive content from the one or more users corresponding to the content generation prompt of the launcher.

7. The apparatus of claim 5, wherein the processor is further operable to:
calculate a total content amount received in response to the launcher; and
calculate a fee for an advertising partner based on the total content amount received.

8. The apparatus of claim 2, wherein the processor is further operable to transmit the content to a social media partner when the aggregate content rating of the content exceeds the predetermined threshold.

9. The apparatus of claim 2, wherein the processor is further operable to:
determine demographic information of the one or more reviewers; and
provide the demographic information with the content in the main content stream.

10. A computer-implemented method comprising:
receiving, by a processor, content;
providing, by the processor, the received content to one or more reviewers;
receiving, by the processor, a content rating from the one or more reviewers;
aggregating, by the processor, the content ratings from the one or more reviewers; and
adding, by the processor, the content to a main content stream when the aggregate content rating of the content exceeds a predetermined threshold.

11. The computer-implemented method of claim 9, comprising providing, by the processor, the content to the one or more reviewers anonymously.

12. The computer-implemented method of claim 11, comprising providing, by the processor, non-user identifying information with the content.

13. The computer-implemented method of claim 10, receiving, by the processor, content ratings comprising one of a positive rating or a negative rating.

14. The computer-implemented method of claim 10, comprising:
receiving, by the processor an indication that a user wishes to be associated with the content;
associating, by the processor, identifying information with the content to identify the user; and
displaying, by the processor, the identifying information with the content in the main content stream.

15. The computer-implemented method of claim 10, comprising:
generating, by the processor, a launcher comprising a content generation prompt; and
receiving, by the processor, content from the one or more users corresponding to the content generation prompt of the launcher.

16. The computer-implemented method of claim 13, comprising:
calculating, by the processor, a total content amount received in response to the launcher; and
calculating, by the processor, a fee for an advertising partner based on the total content amount received.

17. The computer-implemented method of claim 10, comprising transmitting, by the processor, the content to a social media partner when the aggregate content rating of the content exceeds the predetermined threshold.

18. The computer-implemented method of claim 10, comprising:
determining, by the processor, demographic information of the one or more reviewers; and
providing, by the processor, the demographic information with the content in the main content stream.

19. An anonymous content publishing and distribution system for anonymous sharing and public vetting of content comprising:
a processor; and
a non-transitory computer-readable medium coupled to the processor, the non-transitory computer-readable medium configured to store computer program instructions that when executed by the processor are operable to cause the processor to:
receive content from a user;
provide the received content to one or more reviewers, wherein the content is displayed to the one or more reviewers anonymously;
receive a content rating from the one or more reviewers, wherein the content ratings comprise one of a positive rating or a negative rating;
aggregate the content ratings from the one or more reviewers; and
add the content to a main content stream when the aggregate content rating of the content exceeds a predetermined threshold.

20. The anonymous content publishing and distribution system for anonymous sharing and public vetting of content of claim 19, wherein the processor is further operable to:
generate a launcher comprising a content generation prompt; and
receive content from the one or more users corresponding to the content generation prompt of the launcher.
